(19) United States
(12) Patent Application Publication
(10) Pub. No.: US 2013/0034631 A1
(43) Pub. Date: Feb. 7, 2013

(54) Crème le Sucre

(71) Applicant: Patricia Ann Guice, Fairburn, GA (US)

(72) Inventor: Patricia Ann Guice, Fairburn, GA (US)

(21) Appl. No.: 13/567,014

(22) Filed: Aug. 4, 2012

Related U.S. Application Data
(60) Provisional application No. 61/515,734, filed on Aug. 5, 2011.

(51) Int. Cl. A23C 13/12; B65B 29/02

(52) U.S. Cl. 426/77; 426/584; 426/548

(57) ABSTRACT

Crème le Sucre is a mixture of powdered cream and natural or artificial sweetener that can be added to tea or coffee for flavor.

This application claims the benefit of U.S. Provisional Application No. 61/515,734, filed Aug. 5, 2011.

### CROSS-REFERENCE TO RELATED APPLICATIONS

None.

### STATEMENT REGARDING FEDERALLY SPONSORED RESEARCH OR DEVELOPMENT

Not Applicable.

### BACKGROUND OF THE INVENTION

Most people enjoy having a cup of coffee or tea in the morning, at work, during school, or simply throughout the day. These beverages are typically readily available in most places, but it can still be a hassle to add both cream and sugar to the beverage. If at home, individuals have to purchase, store, locate, and use two separate containers, which can be time consuming and inconvenient. Additionally, if getting coffee or tea elsewhere on-the-go, individuals still have to take time and measure out the correct proportions of sugar and cream. An effective solution is necessary.

### BRIEF SUMMARY OF THE INVENTION

Crème le Sucre is a combination of powdered cream and sweetener that can be added to coffee or to tea for flavor. This innovative product can be made of filter paper, which can allow its contents to pass through into the beverage when placed in the mug or cup. Anyone who likes to flavor his or her coffee or tea with cream and sugar will appreciate the convenience and practicality that this product affords.

### DETAILED DESCRIPTION OF INVENTION

Crème le Sucre is a prepackaged mixture of powdered cream and sweetener that can be added to tea or coffee. This unique product can comprise a 2×2 white translucent bag made of filter paper, similar to coffee or tea bags. The packaging of the product can vary, depending on its use. In addition to the small bags, it can be packaged in a reusable container, similar to traditional cream, or it can be offered in bulk sizes. The exact specifications, materials used, and method of use of Crème le Sucre may vary upon manufacturing.

### BRIEF DESCRIPTION OF DRAWINGS ATTACHED

FIG. 1 Shows a person lowering the packet into a cup of coffee.

FIG. 2 Shows the product packaged in small translucent bags.

FIGS. 3-5 Show various packaging options for the product.

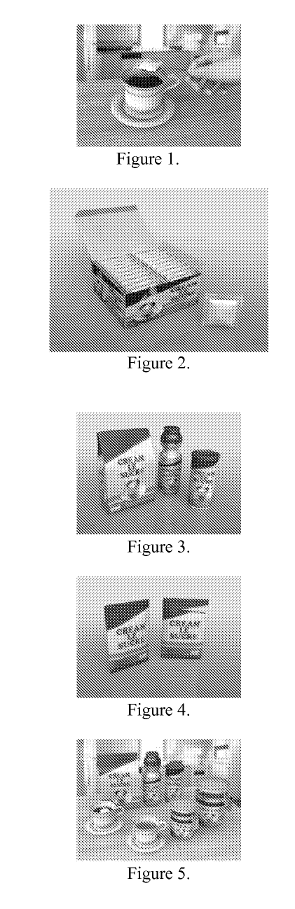

The foregoing descriptions of specific embodiments of the present invention have been presented for purposes of illustration and description. They are not intended to be exhaustive or to limit the present invention to the precise forms disclosed, and obviously many modifications and variations are possible in light of the above teaching. The exemplary embodiment was chosen and described in order to best explain the principles of the present invention and its practical application, to thereby enable others skilled in the art to best utilize the present invention and various embodiments with various modifications as are suited to the particular use contemplated.

1. A mixture comprised of powdered cream and natural or artificial sweetener.

2. The mixture of claim 1 wherein the sweetener is sugar.

3. The mixture of claim 1 wherein the sweetener is Aspartame.

4. The mixture of claim 1 wherein the sweetener is Saccharin.

5. The mixture of claim 1 wherein the sweetener is Sucralose.

6. The mixture of claim 1, wherein the mixture is contained in packets or bags made of filter paper.

7. The mixture of claim 1, wherein the mixture is contained in moisture proof packets containing from one-half to two teaspoons of the mixture.
